(19) United States
(12) Patent Application Publication
(10) Pub. No.: US 2011/0127421 A1
(43) Pub. Date: Jun. 2, 2011

(54) Sample Collection and Detection System

(75) Inventor: Alan Finlay, West Byfleet (GB)

(73) Assignee: Microsaic Systems Limited, Woking (GB)

(21) Appl. No.: 12/956,702

(22) Filed: Nov. 30, 2010

(30) Foreign Application Priority Data
Nov. 30, 2009 (GB) GB0920939.6

(51) Int. Cl. H01J 49/00

(52) U.S. Cl. 250/283; 250/288

(57) ABSTRACT

A sample collection and detection system is described. The detection system provides a sample chamber fluidly coupled to a secondary ionisation source to allow the introduction of vapour generated from the sample into an ion path generated from the secondary ionisation source. The secondary ionisation source is a secondary electrospray ionisation (SESI) source, and is usefully employed in dust analysis.

### CROSS-REFERENCE TO RELATED APPLICATIONS

This application claims the benefit of Great Britain Patent Application No. GB0920939.6 filed on Nov. 30, 2009.

### TECHNICAL FIELD OF THE INVENTION

The present invention relates to on-site chemical analysis of samples and in particular to a detection system for the rapid on-site chemical analysis and to detachable sample collectors for use with detection systems. In particular, the invention provides for a detachable sample collector that operatively mates with a mass spectrometer system and can transfer a collected species of interest to a soft ionization source and a mass spectrometer detector. The invention may also incorporate other stages between the detachable sample collector and the soft ionization source that may allow pre-concentration or chromatography of the species of interest and may also incorporate the functions of an injection volume to an analytical instrument.

### BACKGROUND OF THE INVENTION

Portable chemical detector systems are required for the detection of explosives and other hazardous material. Such systems may be based on separation by gas chromatography (GC), or on GC followed by mass spectrometry (MS), or on ion mobility spectrometry (IMS), or on mass spectrometry (MS) alone. Such systems may or may not use ionization sources at atmospheric or rarefied pressures. Exemplary components of a known system are shown in FIG. 1. The detachable sample collector contains a sample for chemical analysis 101 and is connected to a detector system 102. Because the ambient concentration of the target analyte of interest is vanishingly low, other devices are often incorporated to improve the limit of detection. Such devices are known as pre-concentrators, 103, and will boost the concentration of an analyte of interest in a stream prior to analysis by a detector, 104.

Exemplary components of a known pre-concentrator system are shown in FIG. 2. The pre-concentrator element itself is in essence a trap that will preferentially sorb a dilute analyte from a gas or liquid stream. Within the context of the present invention a sorbent material is one that will sorb a sample from a fluid—be that in the liquid or gaseous phase. To sorb is to take up a liquid or a gas either by adsorption or by absorption. Adsorption is often based on the use of a porous material or a chemically reactive layer of material. Examples of the former are carbon granules and sol-gel glasses, and examples of the latter are functionalised polymers. This material 201 is held on a mechanical support 202, which can be heated. Usually heating is carried out electrically, in that the passing of a current through the support 202 provides a corresponding heating of the support 202.

Detector systems featuring a single-stage pre-concentrator that is also detachable from the detector are known. In some Concepts of Operations (CONOPS), it may not be possible to take the detector system to the sample, and instead the detachable pre-concentrator may be hand-carried to a remote location and used to collect sample. Species of interest are gathered by a sorbent material in the pre-concentrator, and trapped. Once sufficient sample has been collected remotely, the detachable pre-concentrator may be returned to the detector and then coupled with the detector, whereon the species of interest is desorbed and transferred to the detector system for analysis. An example of such an arrangement is shown in WO2006062906.

However, the hand-portable sample collection devices of the type disclosed have the disadvantage of being relatively expensive, bulky units which typically include pumps, sorbent tubes, valves and flow meters. The size and cost of these units limits their deployability—a sample collection device with a weight of four pounds is excessive and cannot be given to every soldier unless it is at the expense of other equipment. More importantly, for the sample collector disclosed in WO2006062906 and similar single stage pre-concentrators, there are difficulties in efficiently transferring the collected sample to the preferred analytical system, a gas chromatography mass spectrometer (GC-MS) without diluting the sample through dead volumes, or loosing sample to ‘cold spots’ or chemically active surfaces. These difficulties may increase the technical complexity of the analysis, increase the duration of the analysis, and lead to loss of potentially valuable sample. In particular, the flow rate, and therefore the response time, of the GC may be limited by the pumping speed of the pumps of the MS vacuum system.

Another form of detector system uses Desorption Electrospray Ionization (DESI) and is a method for desorbing and ionizing an analyte in a sample at ambient atmospheric pressures, comprising generating a DESI-active spray and directing the DESI-active spray into contact with a surface bearing the sample material to desorb and ionise the analyte. The resulting secondary ions may be analyzed to obtain information about the analyte. Examples of such systems include that described in U.S. Pat. No. 7,335,897 B2. However, a major drawback of this technique is that the sample must be presented on a surface, in a liquid or solid phase, to the DESI spray. Vapours cannot be directly analysed by DESI in this fashion. Another drawback is that a loss of ions due to scattering between the sample and the inlet to the mass detector leads to a drop in efficiency. A further drawback is that in the absence of chemical separation the DESI-MS scheme, in the presence of a complex chemical matrix, suffers from chemical interference and a poor signal to noise ratio.

There is therefore a need for improved sample detector systems.

### SUMMARY OF THE INVENTION

These and other problems are addressed by the present invention in providing a detection system that is configured for receipt of a solid sample and which through a heating of that sample effects a generation of vapours which through contact with a secondary ionisation source are ionised and then analysed by a mass spectrometer. The detection system may include a detachable sample collector which if provided allows for the remote collection of the sample to the place of analysis. The detachable sample collector device may be portable for remote sampling. By providing such an arrangement, it is possible to provide for a trapping of ambient samples remotely using a detachable sample collector and to bring the sample so trapped to the detector, rather than vice-versa. Such a system provides response rates that are sufficiently rapid so as to quickly and effectively separate the chemical constituents from a sample containing chemical interferents, and sufficiently selective so as to permit easy identification of chemical species of interest based on their molecular ions and without the need for spectral interpretation. In another arrangement the sample collector is an integral part of the system and the sample is brought to the sample collector as opposed to the other way around.

If provided, the detachable sample collection device is desirably fabricated of relatively simple and inexpensive construction and therefore highly portable. In operational scenarios such as Concepts of Operations (CONOPS) including vehicle and building searches, a cheap, lightweight sample collection device of this kind could be deployed by attaching it to remotely operated vehicles (ROVs), vehicles, unmanned aerial vehicles (UAVs), clothing, flak-vests, helmets and marching-order and so on. In this way, the collection device may be used for search of buildings, roads, vehicles and at checkpoints. By obviating the requirement for complex valve arrangements such a cheap, lightweight arrangement may be provided.

A first embodiment of the detection system provides a sample chamber fluidly coupled to a secondary ionisation source to allow the introduction of a vapour generated from the sample into an ion path generated from the secondary ionisation source, desirably an atmospheric ionisation source API. The interaction between the two effects an ionisation of the molecules within the generated vapour and these ionised molecules are then analysed using the mass spectrometer. If the sample chamber is an element of a detachable sample collector, then there is a requirement for a coupling arrangement to allow for the receipt of a previously removed sample chamber to the other elements of the system. By providing a thermal heating element it is possible to effect a heating of the collected solid sample to provide for generation of vapours therefrom.

In a preferred embodiment, the secondary ionisation source is a secondary electrospray ionisation (SESI) source. In SESI, neutral molecules are ionised by ions emitted by an electrospray ionisation source (ESI). The neutral molecules may be entrained in a vapour, or in uncharged droplets from an aerosol spray. The neutrals interact with the electrospray and secondary electrospray ions are generated. The exact mechanism or mechanisms responsible for ionization of the analyte molecules by SESI remains unclear. There are two generally accepted ionization mechanisms: incorporation of the neutrals into the electrospray droplets; or gas-phase ion-molecule reactions with the electrospray-produced ions. The ESI may include a desolvation gas such as nitrogen or helium which may be used to direct secondary electrospray ions and neutrals to the inlet of the mass spectrometer detector. The mass spectrometer detector can be purely a mass spectrometer (MS) or may contain further elements that separate the neutrals or ions to improve the selectivity and sensitivity of the system.

In one embodiment, the sample collection device of the system invention is a pre-concentrator. The pre-concentrator may be a trap through which the fluid may flow, entry of gas or liquid into the trap being provided through an orifice or other opening into the trap. Such an opening may be provided in a sealable configuration, be that through provision of a permanently breakable seal or a re-sealable entry port through use of, for example, a valve arrangement. However it will be appreciated that as this first stage is typically operable as a detachable sample collector it is not essential to provide such levels of complexity as are typically required for a pre-concentrator. For example, the sample collector could be permanently open allowing free access to the sorbent material, but during periods of non-use the first stage is maintained in a separate sealable container preventing contamination of the sorbent material prior or subsequent to its use. While all that is required is a fluid flow (gaseous or liquid) past the sorbent material, it is useful to have a regular flow and to provide such a regular flow stream the first stage will typically employ a fan or pump to provide a controlled flow of a sample fluid over a region containing some sorbent material. The trap is provided with a sorbent coating configured to selectively sorb the species present in the gas during the flow of gas through the trap. Optimally the trap can also be heated so as to effect desorption of the previously adsorbed species from the sorbent coating.

In a first arrangement the sample collection chamber is configured for receipt of a swipe or wipe with is useable to collect trace elements of the sample. The swipe may be made from a suitable material such as paper or cotton, and the material of the swipe may be coated with sorbent material. Before use, the swipe is held inside a sealable container to prevent contamination. The swipe is taken out of the container and used to collect a gas, liquid or solid samples.

In another embodiment, the sample collector device of the system of the invention may be a dust collector. Dust is used to absorb chemical species of interest, and is collected using a portable device before being presented to the detection system for analysis. The dust collector device either solely, or in-part, mechanically, chemically, magnetically, electro-statically attracts, and captures dust particulate inside the collector device, ready for reattachment to the detection system for chemical analysis. It will be appreciated that dust is a generic name for minute solid particles or particulate matter with diameters less than about 500 microns. This is an example of a non-homogenous sample whereby the parts or elements that form the dust are not of the same kind or type.

In a modification to the system, a chromatographic separator may be provided. In this embodiment the sample is desorbed before being injected through an injector port into a chromatographic separator. The chromatography module then separates the solution mixture into its constituent chemical species and these species are ionised by a soft ionisation source before being analysed and identified by means of a mass spectrometer detector.

In another embodiment of the system includes a sample loop. In this embodiment the sample is desorbed before being injected through an injector port into a sample loop. The sample loop may include a pre-concentrator. The pre-concentrator collects and purifies the chemical species of interest in a sorbent trap which has the effect of concentrating them. Sample is injected into a chromatography system then separates the solution mixture into its constituent chemical species and these species are ionised by a soft ionisation source before being analysed and identified by means of a mass spectrometer detector.

In a first arrangement, the chromatographic separator is a GC column, but the chromatographic separator may also be a liquid chromatography (LC) system, supercritical fluid chromatography (SFC) system or a capillary electrophoresis (CE) system. The GC column rapidly separates the sample mixture and elutes its components into contact with the generated ion beam from the atmospheric pressure ionisation (API) source. Atmospheric ionisation sources typically employ soft ionisation techniques that generate a molecular ion permitting easy interpretation of spectra, limiting fragmentation and easing identification of chemical species particularly when more than one compound elutes simultaneously from the chromatographic column. In a preferred embodiment the atmospheric pressure ionisation source is an electrospray ionisation (ESI) source. The mass spectrometer is coupled to the chromatographic separator by a soft API source which ionises the chemical species as they elute from the chromatographic column. The ions generated by the atmospheric ionisation source are transmitted into the vacuum chamber by an atmospheric pressure interface before being analysed and identified by means of a mass spectrometer detector.

In another arrangement of the detection system, the system includes a detachable sample collector, a GC module and a mass spectrometer detector, and wherein the mass spectrometer comprises a SESI soft ionisation source, a vacuum interface, a mass analyser and an ion counter. Sample is collected using the portable collector which is then coupled to the detection system. Sample is desorbed from the collector before through an injector port into the chromatography column. The mass spectrometer is coupled to the chromatographic separator by the soft ionisation source which ionises the chemical species as they elute from the chromatographic column. The ions are transmitted from the soft ionisation source into a mass analyser inside a vacuum chamber. Ions are transmitted through the vacuum interface and into a mass analyser to be filtered by their mass to charge ratios and counted by the ion counter. A computer processes the signal from the ion counter and it is displayed as a mass spectrum on an analytical display.

In another preferred embodiment of the detection system, the system includes a detachable sample collector, a pre-concentrator, a GC and a mass spectrometer detector, and wherein the mass spectrometer comprises a SESI soft ionisation source, a vacuum interface, a mass analyser and an ion counter. A sample is collected using the portable collector which is then coupled to the detection system. The sample is desorbed from the collector before being transferred through an injector port into a pre-concentrator. The second stage pre-concentrator may also serve as a sample loop and reduces the dead volume of the first stage pre-concentrator or detachable sample collector. The pre-concentrator sample loop desorbs sample which is injected onto the column of the GC. The mass spectrometer is coupled to the GC by the SESI which ionises the chemical species as they elute from the GC column. Ions are transmitted into an ion mobility drift tube and from there into mass analyser inside a vacuum chamber. Ions are then transmitted through the vacuum interface and into a mass analyser to be filtered by their mass to charge ratios and counted by the ion counter. A computer processes the signal from the ion counter and it is displayed as a mass spectrum on an analytical display.

Accordingly a system as claimed in any one of claims to 1 to 12 is provided. A method as detailed in one or more of claims 13 to 17 is also provided.

These and other features and benefit will be understood with reference to the following exemplary embodiments.

### BRIEF DESCRIPTION OF THE DRAWINGS

To understand the present invention, it will now be described by way of example, with reference to the accompanying drawings which:

FIG. 1 shows the elements of a sample collector, pre-concentrator and MS detector, as described in prior art.

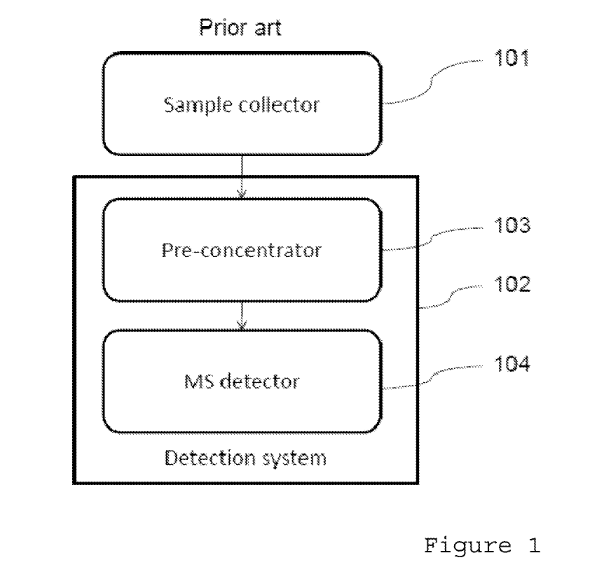

FIG. 2 shows the elements of a chemical pre-concentrator, as described in prior art.

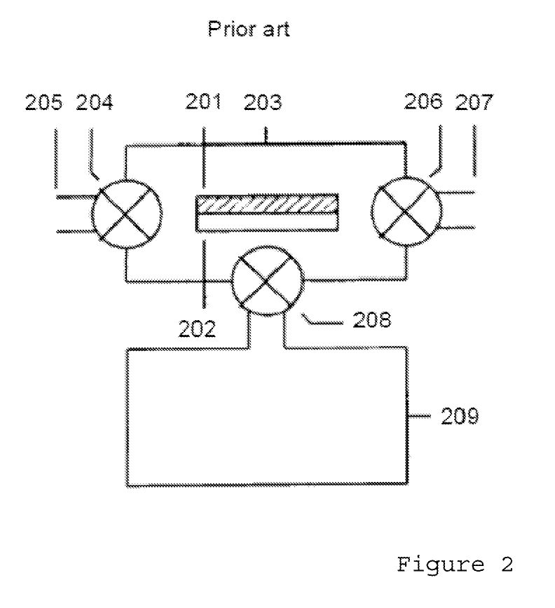

FIG. 3 is a schematic showing the system of the invention.

FIG. 4 shows schematically the invention, using a sample collector stage integrated with a MS detector system and a secondary electrospray ionization source (SESI).

FIG. 5 is a schematic showing one embodiment of the invention incorporating a sample collector, a chromatography module, a SESI source and a MS detector.

FIG. 6 is a schematic showing one embodiment of the invention incorporating a sample collector, a pre-concentrator, a chromatography module, a SESI source and a MS detector.

FIG. 7 is a schematic showing a detection system incorporating a sample collector, a GC, a SESI source and a MS detector.

FIG. 8 is a schematic showing a detection system incorporating a sample collector, a pre-concentrator, a GC, a SESI source and a MS detector.

### DETAILED DESCRIPTION

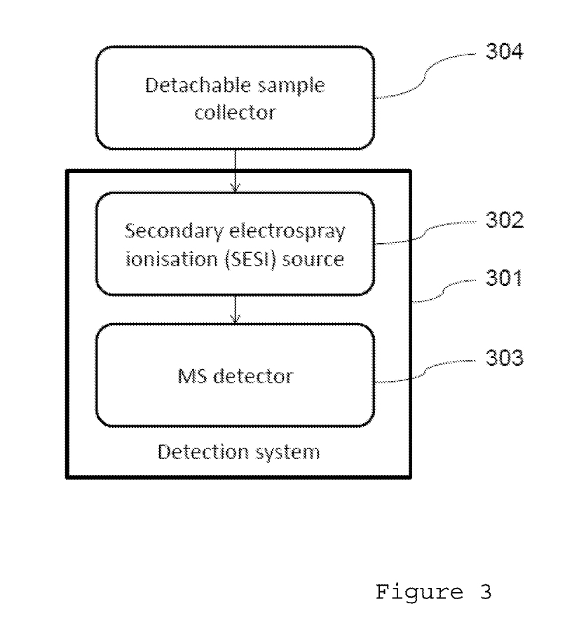

A detailed description of preferred exemplary embodiments of the invention is provided with reference to FIGS. 3 to 10. It will be understood that these embodiments are provided to assist in an understanding of the teaching of the invention and is not intended to limit the scope of the invention to the specifics of the features described herein. Furthermore it will be understood that where elements or features are described with reference to any one specific embodiment or Figure that these could be interchanged with or replaced by those of other embodiments or Figures without departing from the scope of the claimed invention.

It will be appreciated that most samples collected in a ‘real-world’ environment are ‘messy’ e.g. waste water, fuel oil spillage. Samples collected in during building or vehicle searches are generally complex chemical matrices comprising hundreds or even thousands of chemical components. The presence of pollutants, fuel oils and other chemical interferents in concentrations ranging from parts per billion to percentage levels means that lengthy chromatographic separation times are required to ensure adequate separation and purification of all the compounds in the mixture. Gas chromatographic (GC) retention times of hours may be required before all the components have eluted from the column. In fact, some samples of interest may contain tens of thousands of components. While users may not need to separate and identify all of the components during search operations, nonetheless an analytical solution will need to rapidly separate and analyse complex samples and identify their components. In the context of modern counter-IED operations, where hundreds of people, vehicles and buildings must be searched and hundreds of samples collected and hours are needed to analyse them, the opportunity cost of false alarms and missed opportunities is very high. To address these problems there is provided in accordance with the present teaching, a portable sample collector and detection system that provides rapid response times. To achieve this improved response rate, the tool advantageously employs a chromatographic solution featuring a faster flow rate and shorter separation times than heretofore possible. By providing for ionisation of the sample in non-vacuum conditions, the gas chromatographic (GC) flow rate is not limited by the pumping speed of the vacuum pumps and the GC column may have a higher flow rate permitting more rapid separation and a shorter system response time.

It will be appreciated that traditionally where a chromatographic column is used to separate a mixture, a mass spectrometer (MS) detector is used to identify the compounds as they elute. The MS detector is a vacuum instrument and generally features an ion source inside the vacuum chamber to which the GC column is coupled and which ionises molecules of each constituent compound as they elute from the column. Typical ion sources used with GC are electron ionisation (EI) and chemical ionisation (CI). Both EI and CI take place inside the vacuum chamber and involve bombarding eluted molecules with energetic electrons or ions, fragmenting the neutral molecules and producing charged particles (i.e. ions). This fragmentation adds further complexity where some many chemicals are concerned, leading to mass spectral interpretation and further delays. Problems arise when component co-elute from the column and fragments over-lap. Over lapping fragments can make it impossible to separate mass spectra and identify compounds. Co-eluting compounds will be a problem when separations are accelerated by increasing flow rate or temperature ramp for example. To address these shortcomings of previous systems, a system in accordance with the present teaching employs a ‘soft’ ionisation source that does not fragment chemical species but which instead produces one ‘molecular ion’, whose mass to charge ratio corresponds to it molecular weight, is a faster and easier means of identifying eluted compounds. The use of soft ionisation permits identification of compounds during rapid separation of compounds. Such a ‘soft’ ionisation processes may be conducted outside the GC vacuum chamber at elevated pressures and include those provided by secondary electrospray ionisation (SESI).

FIG. 3 describes in schematic form the detection system of the invention. A detection system 301 is described incorporating a SESI source 302, a MS detector 303, and a sample collector 304. The sample collector 304 is detachable from the detection system 301 and is be hand-portable and is used to gather sample remotely from the detection system. The sample collector may be a relatively simple, lightweight and cheap assembly manufactured using commercial-of-the-shelf components, and if used in military operations, may be carried on soldiers' clothing, body armour, webbing or helmet. The sample collector 304 is based on a swipe, dust collector, solid phase micro-extraction (SPME) fibre or pre-concentrator or some combination of the above. After the sample has been collected, the sample collector 304 is reinserted into a mounting and reattached to the detection system 301 so that the collector is fluidically coupled with the SESI source 302. The sample collector 304 may be heated, or electrically connected to the detection system so that the sorbent material of the sample collector 304 may be heated, desorbing analyte of interest for ionization by the SESI source 302. The ions generated by source 302 are transmitted through a vacuum interface and into a mass spectrometer (MS) detector 303 to be filtered by their mass to charge ratios and counted by the ion counter. The MS 303 may be based on, and not limited to, an ion trap, quadrupole, time of flight, toroidal ion trap, orbital ion trap, linear ion trap, rectilinear ion trap, triple quadrupole, rotating field, magnetic sector, crossed field, cycloidal or fourier transform mass analyser. Ions are filtered by their mass to charge ratios in the analyser and impact the ion counter generating an electrical current. This current is a signal that may be amplified and filtered by ion counter electronics and processed by a computer before being displayed as chromatograms and mass spectra in an analytical software application.

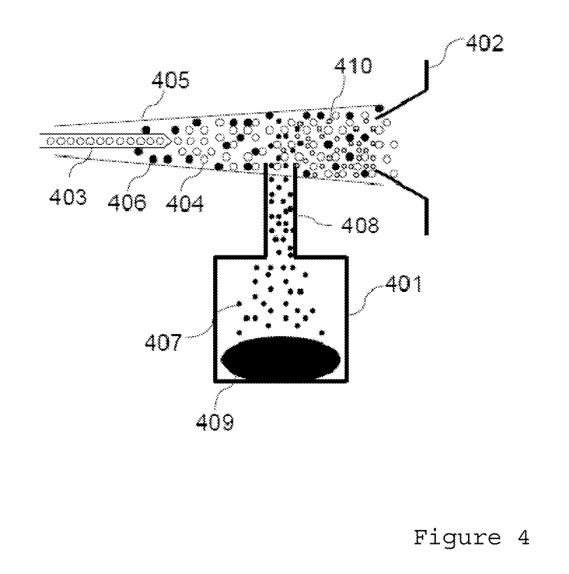

FIG. 4 describes the detection system of FIG. 3 in greater detail. The sample collector 409 is placed inside a housing 401. The housing 401 is coupled to the inlet of a MS detector system 402 and a SESI source 406. Primary ions 404 are generated from an electrospray ionization source comprising a capillary tip 403 held at a high voltage spraying solution droplets. Neutral molecules 407 are desorbed from the collected sample 409. Analyte neutrals 407 interact with primary ions 404 to generate secondary ions 410 and a nebuliser gas 405 containing neutrals 406 is used to desolvate and nebulise ionised droplets 404 from the capillary 403, and to direct the secondary ions 410 to the entrance of the mass spectrometer 402. The sample collector 409 may be heated to desorb samples into the enclosure of the SESI source 406. Heating may be by electrical current, resistive, radiation, photonic, induction or microwave means. The secondary ions 410 reach the atmospheric inlet 402 to the mass spectrometer detector system held 403 inside a vacuum system.

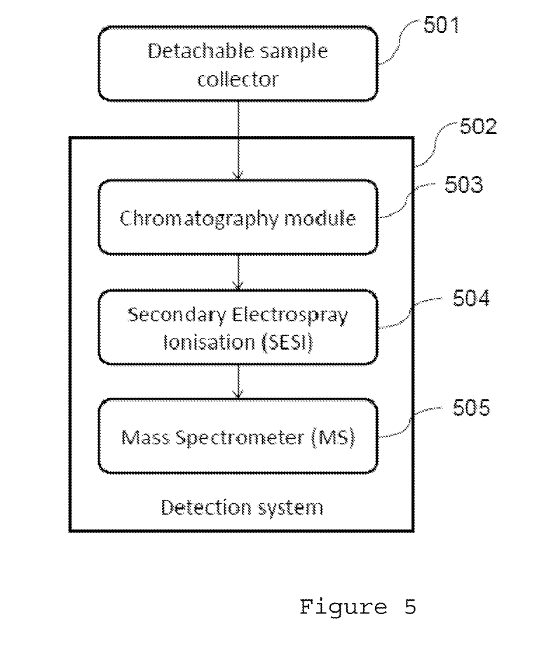

FIG. 5 is a schematic of an embodiment of the detector system of invention. A detachable sample collector 501 is mated with a detection system 502 so that it is fluidically coupled with a chromatography module 503. The sample is desorbed from the collector 501 and injected onto the chromatography module 503 which separates the chemical constituents of the sample so that they elute into a SESI source 504. By employing a soft ionisation source such as the exemplary SESI source that effects ionisation of the sample in non-vacuum conditions, the flow rate of the chromatographic column 503 is not limited by the pumping speed of the vacuum pumps of the mass spectrometer 505, and the column may have a higher flow rate permitting more rapid separation and a shorter system response time. Soft ionisation techniques such as SESI, i.e. the formation of ions without breaking chemical bonds, are particularly advantageous in the context of the chemically complex samples as described herein in that soft ionisation advantageously produces one ‘molecular ion’, whose mass to charge ratio or time of flight corresponds to it molecular weight, and has is a faster and easier means of identifying eluted compounds. The separation of the fluid into its chemical constituents has been described with reference to the exemplary use of a chromatography column 503 that could be a gas, liquid or supercritical fluid based chromatography module. In a preferred embodiment chromatography module 503 is a GC. However it is possible to separate mixtures using other separation techniques such as ion mobility or capillary electrophoresis and the use of such techniques should be considered within the context of the chromatography module 503 described herein. Ions generated by the SESI source are transferred to a mass spectrometer 505 which filters ions by their mass to charge ratios and measures their abundance using an ion counter. A computer processes the signal from the ion counter which is displayed as a mass spectrum on an analytical display of the detection system 502.

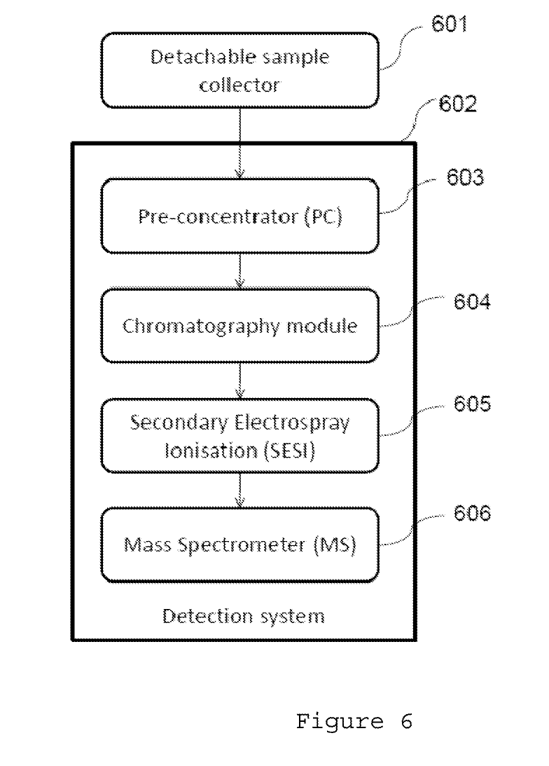

FIG. 6 is a schematic of an embodiment of the detector system of invention. A detachable sample collector 601 is used to collect sample remotely from the system. The detachable sample collector 601 is portable and may be a swipe, dust collector, pre-concentrator or SPME fibre. The detachable sample collector 601 is mated with a detection system 602 so that it is fluidically coupled with a pre-concentrator 603. The sample collector desorbs the chemical species of interest into the pre-concentrator 603. The pre-concentrator 603 serves to reduce dead-volumes and to prevent dilution of the sample before injection into the chromatography module 604. The pre-concentrator 603 collects the species of interest by means of for example a sorbent trap before they are loaded onto a chromatography column. The pre-concentrator 603 purifies the chemical species of interest in which has the effect of concentrating them into a small injection volume before the mixture is injected onto the column 604 and separated into its individual components by means of chromatography. The pre-concentrator 603 may also function as a sample loop and is used to inject a measured volume of sample onto chromatography module 604. The chromatography module 604 is preferable a GC, but could also be liquid or supercritical fluid based chromatography. The chemical constituents of the sample are separated by the chromatography module 604 and elute in order of their mobility in the chromatography module 604 into a SESI source 605 where the species of interest undergo a process of ‘soft’ ionisation through interaction with ions from a primary electrospray source. The secondary ions are transferred into a MS detector 606 via a vacuum interface. The MS 606 filters ions by their mass to charge ratios and measures their abundance using an ion counter. A computer processes the signal from the ion counter which is displayed as a mass spectrum on an analytical display of the detection system 602.

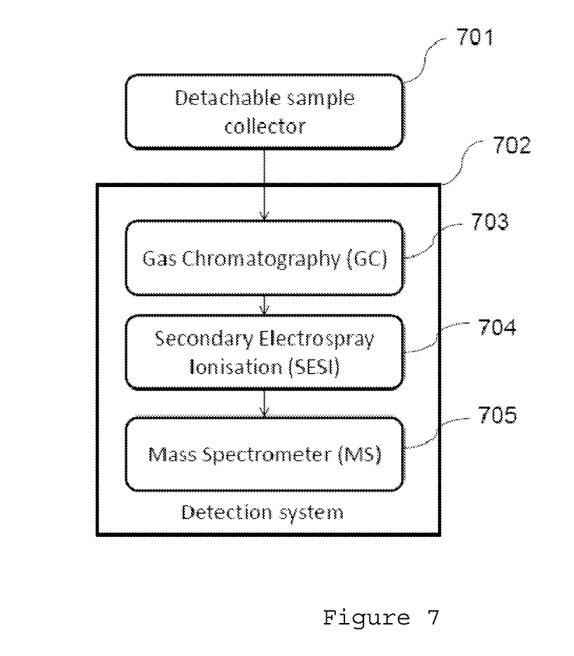

In FIG. 7 shows a preferred embodiment of the detection system of the invention. A detachable sample collector 701 may be a swipe, syringe, pre-concentrator, SPME fibre or dust collector and is used to collect sample remotely from detection system 702. The sample collector 701 is attached to system 702 so that it is fluidically coupled with a GC module 703. The sample is transferred from collector 701 to GC 703. The chemical constituents of the sample are separated by gas chromatography in 703 and elute in order of their mobility from the GC 703 into a SESI source 704 where the species of interest undergo a process of ‘soft’ ionisation through interaction with ions from a primary electrospray source. The secondary ions are transferred into a MS detector 705 via a vacuum interface. The MS 705 filters ions by their mass to charge ratios and measures their abundance using an ion counter. A computer processes the signal from the ion counter which is displayed as a mass spectrum on an analytical display of the detection system 702.

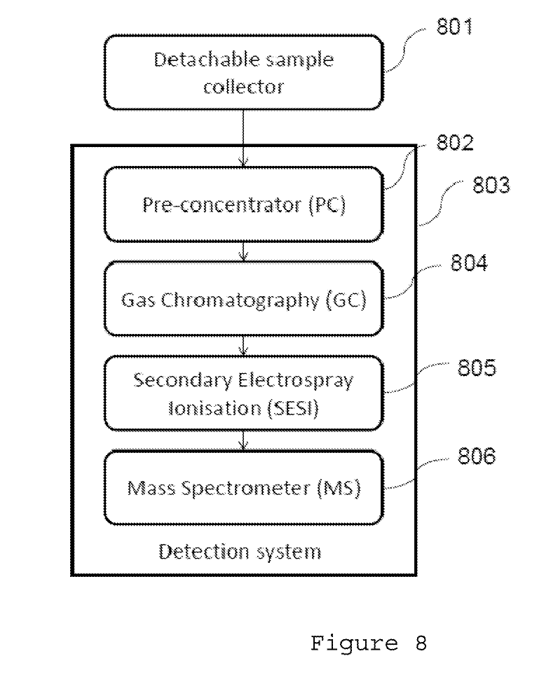

In FIG. 8 shows another preferred embodiment of the detection system of the invention. A detachable sample collector 801 may be a swipe, syringe, pre-concentrator, SPME fibre or dust collector and is used to collect sample remotely from detection system 803. The sample collector 801 is attached to system 803 so that it is fluidically coupled with a pre-concentrator 802. The sample is transferred from collector 801 to pre-concentrator 802. The pre-concentrator 802 serves to reduce dead-volumes and to prevent dilution of the sample before injection into the GC module 804. The pre-concentrator 802 collects the species of interest by means of for example a sorbent trap before they are loaded onto a chromatography column. The pre-concentrator 802 purifies the chemical species of interest in which has the effect of concentrating them into a small injection volume before the mixture is injected onto the column of GC 804 and separated into its individual components by means of chromatography. The pre-concentrator 802 may also function as a sample loop and is used to inject a measured volume of sample onto GC module 804. The chemical constituents of the sample are separated by gas chromatography in 804 and elute in order of their mobility from the GC 804 into a SESI source 805 where the species of interest undergo a process of ‘soft’ ionisation through interaction with ions from a primary electrospray source. The secondary ions are transferred into a MS detector 806 via a vacuum interface. The MS 806 filters ions by their mass to charge ratios and measures their abundance using an ion counter. A computer processes the signal from the ion counter which is displayed as a mass spectrum on an analytical display of the detection system 803.

While the specifics of the mass spectrometer have not been described herein a portable instrument such as that described herein may be advantageously manufactured using microengineered instruments such as those described in one or more of the following co-assigned US applications: U.S. patent application Ser. No. 12/380,002, U.S. patent application Ser. No. 12/220,321, U.S. patent application Ser. No. 12/284,778, U.S. patent application Ser. No. 12/001,796, U.S. patent application Ser. No. 11/810,052, U.S. patent application Ser. No. 11/711,142 the contents of which are incorporated herein by way of reference. Within the context of the present invention the term microengineered or microengineering or micro-fabricated or microfabrication is intended to define the fabrication of three dimensional structures and devices with dimensions in the order of millimetres or sub-millimetre scale.

Where done at micron-scale, it combines the technologies of microelectronics and micromachining. Microelectronics allows the fabrication of integrated circuits from silicon wafers whereas micromachining is the production of three-dimensional structures, primarily from silicon wafers. This may be achieved by removal of material from the wafer or addition of material on or in the wafer. The attractions of microengineering may be summarised as batch fabrication of devices leading to reduced production costs, miniaturisation resulting in materials savings, miniaturisation resulting in faster response times and reduced device invasiveness. Wide varieties of techniques exist for the microengineering of wafers, and will be well known to the person skilled in the art. The techniques may be divided into those related to the removal of material and those pertaining to the deposition or addition of material to the wafer. Examples of the former include:

Wet chemical etching (anisotropic and isotropic)

Electrochemical or photo assisted electrochemical etching

Dry plasma or reactive ion etching

Ion beam milling

Laser machining

Excimer laser machining

Electrical discharge machining

Whereas examples of the latter include:

Evaporation

Thick film deposition

Sputtering

Electroplating

Electroforming

Moulding

Chemical vapour deposition (CVD)

Epitaxy

While exemplary arrangements have been described herein to assist in an understanding of the present teaching it will be understood that modifications can be made without departing from the spirit and or scope of the present teaching. To that end it will be understood that the present teaching should be construed as limited only insofar as is deemed necessary in the light of the claims that follow.

Furthermore, the words comprises/comprising when used in this specification are to specify the presence of stated features, integers, steps or components but does not preclude the presence or addition of one or more other features, integers, steps, components or groups thereof.

1. A detection system for on-site analysis and identification of samples, the system comprising:
a. a sample chamber for receiving a non-homogeneous solid sample comprising dust or particulate matter;
b. a thermal desorber for heating the received sample within the sample chamber to effect generation of a vapour from the received sample;
c. a secondary electrospray soft-ionisation source, operably in fluid communication with the sample chamber to effect an ionisation of the generated vapour to form molecular ions without breaking chemical bonds;
d. a mass spectrometer detector configured for receiving the molecular ions, the mass spectrometer system providing an identification of chemical components of the sample based on an analysis of the molecular ions.

2. The system of claim 1 comprising a chromatography module for separating the sample into its constituent chemical species, the secondary electrospray ionisation source coupling the chromatography module to the mass spectrometer, wherein the mass spectrometer identifies chemical components of the sample by their molecular ions as they are eluted by the chromatography module and ionised by the ionisation source.

3. The system of claim 2 wherein operably the sample is desorbed from the sample chamber and injected onto the chromatography module which separates the chemical constituents of the sample so that they elute into the secondary electrospray ionisation source.

4. The system of claim 1 wherein the sample chamber comprises an entry port for introduction of a sample, the entry port having an open and a closed position, adoption of the closed position effecting a sealing of the sample chamber.

5. The system of claim 1 wherein the secondary electrospray ionisation source operably provides a desolvation gas such as nitrogen or helium to direct secondary electrospray ions and neutrals to the mass spectrometer detector.

6. The system of claim 1 comprising a pre-concentrator provided in the fluid path between the sample chamber and the secondary electrospray ionisation source, the pre-concentrator operably reducing dead-volumes and minimising a dilution of the sample before subsequent analysis.

7. The system of claim 6 wherein the pre-concentrator provides a sample loop which operably increases the concentration of the sample prior to subsequent analysis of the sample by other constituents of the system.

8. The system of claim 1 wherein the sample chamber is detachable from the secondary ionisation source to allow a collection of a sample at a location remote from the secondary ionisation source.

9. The system of claim 1 configured to capture and retain dust particles through at least one of a mechanical, chemical, magnetic or electro-static process.

10. The system of claim 1 comprising a vacuum interface between the secondary electrospray ionisation source and the mass spectrometer.

11. The system of claim 1 wherein the mass spectrometer is a microengineered device.

12. The system of claim 1 wherein the soft-ionisation source is operable in non-vacuum substantially atmospheric conditions.

13. The system of claim 1 wherein the thermal desorber operably heats the sample by one of electrical current, resistive, radiation, photonic, induction or microwave means.

14. A method of identifying constituents of a sample, the method comprising:
a. Providing a detection system;
b. Introducing a solid sample into the sample chamber;
c. Effecting, using the thermal desorber, a heating of the sample to effect generation of a vapour;
d. Bringing the vapour into contact with an ion beam from the secondary electrospray soft ionisation source to effecting an ionisation of the generated vapour to form molecular ions without breaking chemical bonds;
e. Introducing the molecular ions into the mass spectrometer detector to provide an identification of chemical components of the sample based on an analysis of their molecular ions

15. The method of claim 14 wherein the solid sample comprises particulate matter.

16. The method of claim 14 wherein the solid sample comprises dust.

17. The method of claim 16 wherein the dust is collected remotely from the detection system and is retained on a sample collector which is then introduced into the sample chamber.

18. The method of claim 16 wherein the dust is collected using a wipe or other absorbent material.
